(19) United States
(12) Patent Application Publication
(10) Pub. No.: US 2024/0297685 A1
(43) Pub. Date: Sep. 5, 2024

(54) COOPERATIVE LEARNING METHOD AND APPARATUS FOR POWER ALLOCATION IN DISTRIBUTED MULTIPLE INPUT AND MULTIPLE OUTPUT SYSTEM

(71) Applicant: ELECTRONICS AND TELECOMMUNICATIONS RESEARCH INSTITUTE, Daejeon (KR)

(72) Inventors: Seung Eun HONG, Daejeon (KR); Seok Hwan PARK, Jeonju-si (KR); Dae Sung YU, Jeonju-si (KR); Hoon LEE, Busan (KR)

(73) Assignee: ELECTRONICS AND TELECOMMUNICATIONS RESEARCH INSTITUTE, Daejeon (KR)

(21) Appl. No.: 18/594,545

(22) Filed: Mar. 4, 2024

(30) Foreign Application Priority Data
Mar. 3, 2023 (KR) 10-2023-0028679

(51) Int. Cl. H04B 7/0426; H04B 7/024; H04W 52/24; H04W 52/28; H04W 52/40

(52) U.S. Cl. CPC H04B 7/0426; H04B 7/024; H04W 52/242; H04W 52/282; H04W 52/40

(57) ABSTRACT

A method for power allocation in a dAP may comprise: when a change cycle of a transmit power determination vector arrives, generating an uplink message including long-term CSI, the uplink message being normalized such that the long-term local CSI becomes a value within a preconfigured limit range; transmitting the uplink message to a central processing unit through a fronthaul; receiving a downlink message vector for power allocation from the central processing unit through the fronthaul; generating decentralized determination information using the downlink message vector; and extracting a transmit power determination vector based on the decentralized determination information.

### CROSS-REFERENCE TO RELATED APPLICATIONS

This application claims priority to Korean Patent Application No. 10-2023-0028679, filed on Mar. 3, 2023, with the Korean Intellectual Property Office (KIPO), the entire contents of which are hereby incorporated by reference.

### BACKGROUND

### 1. Technical Field

The present disclosure relates to a power allocation technique, and more particularly, to a power allocation technique in a distributed multiple input and multiple output (MIMO) system.

### 2. Related Art

To address the escalating wireless traffic, beamforming technologies have been introduced in wireless communication systems. These technologies enable the simultaneous transmission of multiple data streams through multiple antennas in space. Moreover, the deployment of base stations in densely populated areas has facilitated the provision of services to a larger number of users. However, this dense deployment also leads to increased interference between users. Therefore, enhancing the performance of wireless communication systems is contingent upon effective interference control.

To effectively control interference, it's essential to leverage complete channel information across multiple transmitters/receivers. A distributed multiple input multiple output (MIMO) system, comprising a centralized processing unit (CPU) and multiple distributed access points (dAPs) like a cloud radio access network (C-RAN) and cell-free massive MIMO (CFmMIMO) systems, has been introduced for this purpose. In a distributed MIMO system, the CPU can execute various processes utilizing global channel information between the dAPs and user equipment (UEs). For instance, it can compute a beamforming vector for each user, determining beam direction (e.g. precoding) and beam strength (e.g. power allocation), to mitigate interference based on this global channel information. Furthermore, the CPU can optimize system performance, such as maximizing total data rate or ensuring a minimum user data rate, by simultaneously transmitting data to multiple users using tailored beamforming vectors.

To enable the CPU to construct the global channel state information and calculate the beamforming vector, the local channel information from multiple dAPs should be transmitted to the CPU. Additionally, the CPU should perform complex calculations using the constructed global channel information to determine the beamforming vectors. In this scenario, the dAPs and CPU are connected via a fronthaul network.

The method for collecting and calculating the described information involves delivering instantaneous local channel information over the fronthaul, leading to significant fronthaul overhead and transmission latencies. While the CPU can gather this information and derive optimal solutions based on global channel information, challenges arise in increasing the required fronthaul capacity due to overhead, ensuring timely transmission of global channel information due to latency, and guaranteeing real-time derivation and application of beamforming vectors through complex calculations.

To address these issues, especially in CFmMIMO systems, a proposed method involves performing precoding based on local channel information at each dAP and transmitting statistical channel information, such as channel covariance, from each dAP to the CPU at longer time intervals instead of instantaneously. Despite this approach, which aims to mitigate the inefficiencies of precoding based on local channel information, the distributed method still necessitates complex power allocation optimization calculations in the CPU. Moreover, performance degradation may occur due to inaccuracies in power allocation based on global statistical channel information.

### SUMMARY

The present disclosure for resolving the above-described problems is direct to providing a method and an apparatus for power cooperative learning-based power allocation that fully utilizes computation capabilities of distributed nodes while reducing fronthaul overhead to simultaneously provide services to multiple users in a wireless distributed MIMO system.

A method according to an exemplary embodiment of the present disclosure for achieving the above-described objective, as a method for, may comprise: when a change cycle of a transmit power determination vector arrives, generating an uplink message including long-term local channel state information (CSI), the uplink message being normalized such that the long-term local CSI becomes a value within a preconfigured limit range; transmitting the uplink message to a central processing unit through a fronthaul; receiving a downlink message vector for power allocation from the central processing unit through the fronthaul; generating decentralized determination information using the downlink message vector; and extracting a transmit power determination vector based on the decentralized determination information, wherein the decentralized determination information includes an output vector for generating a local power allocation value and a variable for the dAP.

The method may further comprise: extracting power allocation information corresponding to each of terminals based on the decentralized determination information; determining a transmit power for a channel transmitted to each of the terminals based on the power allocation information; and communicating with each of the terminals by using the determined transmit power.

The transmit power for the channel transmitted to each of the terminals may be determined by a third preconfigured deep neural network (DNN).

The long-term local CSI may be calculated based on channel state information and a long-term path loss with each of communicating terminals.

The normalized uplink message may have a length preset by the central processing unit.

The normalized uplink message may be generated by a first preconfigured DNN.

The change cycle of the transmit power determination vector may be determined based on a channel change cycle between a terminal and the dAP.

The change cycle of the transmit power determination vector may be preset by the central processing unit.

The change cycle of the transmit power determination vector may be determined differently for each group based on a movement speed of terminals communicating within the dAP.

A method of a central processing unit according to an exemplary embodiment of the present disclosure may comprise: when an update cycle of a downlink message arrives, receiving uplink messages corresponding to long-term local channel state information (CSI) respectively from two or more distributed access points (dAPs) communicating with terminals through a fronthaul; generating one downlink message based on a pooling operation on the received uplink messages; and transmitting the downlink message to the dAPs, wherein each of the uplink messages is information normalized to a value within a preconfigured limit range.

The one downlink message may be generated by a preconfigured second deep neural network (DNN).

The method may further comprise: configuring length information of the uplink message to each of the dAPs.

The central processing unit may be an open-radio access network (O-RAN) central unit (CU) of an O-RAN system.

The update cycle of the downlink message may be determined based on channel state change information received from each of the dAPs.

The method may further comprise: transmitting information on the update cycle of the downlink message to each of the dAPs.

A distributed access point (dAP) according to an exemplary embodiment of the present disclosure may comprise: a processor, and the processor may cause the dAP to perform: when a change cycle of a transmit power determination vector arrives, generating an uplink message including long-term local channel state information (CSI), the uplink message being normalized such that the long-term local CSI becomes a value within a preconfigured limit range; transmitting the uplink message to a central processing unit through a fronthaul; receiving a downlink message vector for power allocation from the central processing unit through the fronthaul; generating decentralized determination information using the downlink message vector; and extracting a transmit power determination vector based on the decentralized determination information, wherein the decentralized determination information includes an output vector for generating a local power allocation value and a variable for the dAP.

The processor may further cause the dAP to perform: extracting power allocation information corresponding to each of terminals based on the decentralized determination information; determining a transmit power for a channel transmitted to each of the terminals based on the power allocation information; and communicating with each of the terminals by using the determined transmit power.

The transmit power for the channel transmitted to each of the terminals may be determined by a third preconfigured deep neural network (DNN).

The long-term local CSI may be calculated based on channel state information and a long-term path loss with each of communicating terminals.

The normalized uplink message may have a length preset by the central processing unit.

According to exemplary embodiments of the present disclosure, a collaborative learning-based distributed power allocation method and apparatus are utilized to determine beam precoding and beam strength at each dAP in a distributed MIMO system, including CFmMIMO. This enables the calculation of beamforming vectors. Specifically, the present disclosure facilitates the accurate calculation of beamforming vectors even in scenarios where frequent data, such as measured short-term channel state information, is not provided through fronthaul in an O-RAN system. In essence, accurate beamforming vectors can be computed while reducing fronthaul overhead. Additionally, the advantage of real-time beamforming vector calculation is also provided.

### BRIEF DESCRIPTION OF DRAWINGS

FIG. 1 is a conceptual diagram illustrating a transmission structure of a distributed MIMO system.

FIG. 2A is a flowchart for cooperative learning with CPU at dAP according to an exemplary embodiment of the present disclosure.

FIG. 2B is a flowchart for cooperative learning with each dAP at CPU according to an exemplary embodiment of the present disclosure.

FIG. 3A is a conceptual diagram for describing a structure of an uplink fronthaul cooperation message generation operator DNN among the cooperative learning operation functions according to the present disclosure.

FIG. 3B is a conceptual diagram for describing a structure of a downlink fronthaul cooperation message generation operator DNN among the cooperative learning operation functions according to the present disclosure.

FIG. 3C is a conceptual diagram for describing a structure of a distributed power allocation determination operator DNN among the cooperative learning operation functions according to the present disclosure.

FIG. 4 is a conceptual diagram for describing a cooperative learning-based power allocation deep neural network structure according to an exemplary embodiment of the present disclosure.

FIG. 5 is a conceptual diagram of an open RAN system configuration to which a cooperative learning-based DNN according to the present disclosure is applied.

FIG. 6 is a conceptual diagram illustrating block configuration of a device according to an exemplary embodiment of the present disclosure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

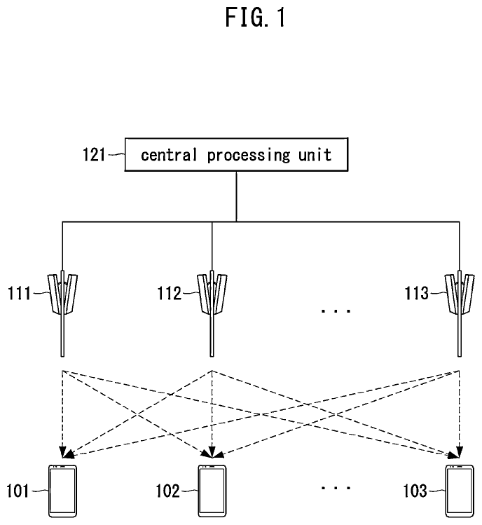

FIG. 1 is a conceptual diagram illustrating a transmission structure of a distributed MIMO system.

Referring to FIG. 1, a plurality of terminals 101, 102, . . . and 103 may communicate with a plurality of dAPs 111, 112, . . . , and 113. The dAPs 111, 112, . . . , and 113 may be connected to a CPU 121 through a fronthaul network.

It is assumed that the distributed MIMO system illustrated in FIG. 1 includes one CPU 121, M dAPs 111, 112, . . . , and 113, and K terminals 101, 102, . . . , and 103. The CPU 121 of the distributed MIMO system may provide services simultaneously to K terminals 101, 102, . . . , and 103 through M dAPs 111, 112, . . . , and 113. In other words, as shown by dotted arrows in FIG. 1, the M dAPs 111, 112, . . . , and 113 may perform downlink transmission of a multi-user beamforming system that simultaneously serves K terminals 101, 102, . . . , and 103.

In the present disclosure, for convenience of description, it is assumed that each of the dAPs 111, 112, . . . , and 113 has a single antenna. However, each of the M dAPs 111, 112, . . . , and 113 and the K terminals 101, 102, . . . , and 103 may have a plurality of antennas. In this case, the number of antennas or antenna panels may be two or more, and all of the M dAPs 111, 112, . . . , and 113 may have the same number of antennas or antenna panels. As another example, each of the M dAPs 111, 112, . . . , and 113 may have a different number of antennas or a different number of antenna panels. The K terminals 101, 102, . . . , and 103 may all have the same number of antennas, or each of the K terminals 101, 102, . . . , and 103 may have a different number of antennas.

In addition, for convenience of description, it is assumed that the maximum transmit power of each of the dAPs 111, 112, . . . , and 113 has the same value of P, and a fronthaul link between the CPU 121 and each of the dAPs 111, 112, . . . , and 113 also has the same limited capacity. However, the present disclosure is not limited thereto, and based on the description below, a transmit power of each of the dAPs 111, 112, . . . , and 113 may have a different value. In addition, the fronthaul link capacity between each the dAPs 111, 112, . . . , and 113 and the CPU 121 may be configured to a different value. For example, the fronthaul link capacities configured to different values may mean that a fronthaul link capacity between the first dAP 111 and the CPU 121 is configured to a first value, and the fronthaul link capacity between the second dAP 112 and the CPU 121 is configured to a second value different from the first value.

In the configuration of FIG. 1, an index set of the dAPs 111, 112, . . . , and 113 may be defined as Equation 1 below, and an index set of the terminals 101, 102, . . . , and 103 may be defined as Equation 2 below.

$$ℳ {=}^{△} \{ 1 , 2 , … , M \} \qquad [ Equation 1 ]$$

$$𝒦 {=}^{△} \{ 1 , 2 , … , K \} \qquad [ Equation 2 ]$$

In Equation 1 and Equation 2, M may correspond to the number of dAPs, and K may correspond to the number of terminals.

When channel coefficients between the m-th dAP and the k-th terminal are h_{k,m}, the channel coefficients may usually follow a distribution of h_{k,m}˜ [symbol] (0, ρ_{k,m}) based on Gaussian noises, and a long-term path loss of a link between the m-th dAP and the k-th terminal may be expressed as Equation 3 below.

$${ρ}_{k , m} {=}^{△} 𝔼 [ {\vert {h}_{k , m} \vert}^{2} ] \qquad [ Equation 3 ]$$

Using a standard channel acquisition process, actual local channel state information (CSI) for each of the dAPs 111, 112, . . . , and 113 may be obtained as Equation 4 below, and an estimate of the local CSI may be obtained as Equation 5 below. A value of Equation 5 may be a short-term local CSI estimate or a short-term CSI estimate.

$${h}_{m} {=}^{△} {\{ {h}_{k , m} \}}_{k ∈ 𝒦} \qquad [ Equation 4 ]$$

$${\hat{h}}_{m} {=}^{△} {\{ {\hat{h}}_{k , m} \}}_{k ∈ 𝒦} \qquad [ Equation 5 ]$$

In Equation 5, ĥ_{k,m} may be modeled as in Equation 6 below.

$${h}_{k , m} = {\hat{h}}_{k , m} + {e}_{k , m} \qquad [ Equation 6 ]$$

In Equation 6, e_{k,m} is a channel estimation error. When using a linear MMSE estimator, e_{k,m} is independent of ĥ_{k,m}. ĥ_{k,m} and e_{k,m} follow distributions shown in Equation 7 below, respectively.

$${\hat{h}}_{k , m} ∼ ( 0 , ( 1 - ϕ ) {ρ}_{k , m} ) and {e}_{k , m} ∼ ( 0 , {ϕρ}_{k , m} ) \qquad [ Equation 7 ]$$

In Equation 7, ϕ has a value of [0,1] and represents an error rate. The error rate may depend on a signal to noise ratio (SNR) of a pilot symbol. Therefore, the error rate may be regarded as an arbitrary value that changes dynamically depending on a propagation environment. In addition, statistics on the channel coefficients may be obtained through mathematical channel modeling or may be obtained from channel big data obtained from an actual system.

In case of centralized interference management, the local CSI estimate [symbol] needs to be shared with the CPU 121 through fronthaul coordination. However, these frequent updates of short-term CSIs result in significant fronthauling overhead. As an example of solutions to reduce the fronthaul overhead may be that each of the dAPs 111, 112, . . . , and 113 delivers its local long-term CSI to the CPU 121. Here, the local long-term CSI may be expressed as Equation 8 below.

$${ρ}_{m} = {\{ {ρ}_{k , m} \}}_{k ∈ 𝒦} \qquad [ Equation 8 ]$$

By having each of the dAPs 111, 112, . . . , and 113 deliver its local long-term CSI to the CPU 121, the CPU 121 can reduce signaling overhead in fronthaul coordination. In addition, the CPU 121 can mitigate interference between users by using long-term fading.

The m-th dAP may calculate a beam-direction setting precoding w_{k,m} for the k-th terminal using only its local CSI. In general, as a precoding scheme using local CSI, a conjugate beamforming (hereinafter ‘CB’) scheme and a local regularized zero forcing (hereinafter ‘L-RZF’) scheme may be used, and these are calculated using Equation 9 below.

$${w}_{k , m} = \{ \begin{matrix}\frac{{\hat{h}}_{k , m}^{*}}{\vert {\hat{h}}_{k , m}^{*} \vert} , & CB \\ \frac{{\hat{h}}_{k , m}^{*}}{{\vert {\hat{h}}_{k , m}^{*} \vert}^{2} + 1} / \sqrt{𝔼 \{ \frac{{\vert {\hat{h}}_{k , m}^{*} \vert}^{2}}{{( {\vert {\hat{h}}_{k , m}^{*} \vert}^{2} + 1 )}^{2}} \} ,} & L - RZF\end{matrix} \qquad [ Equation 9 ]$$

A transmit signal xₘ of the m-th dAP may be expressed as Equation 10 below.

$${x}_{m} = {\sum }_{k ∈ 𝒦} \sqrt{{p}_{k , m}} {w}_{k , m} {s}_{k} , m ∈ ℳ \qquad [ Equation 10 ]$$

In Equation 10, sₖ may represent a data symbol for the k-th terminal, and p_{k,m} may represent a transmit power allocated to transmit sₖ by the m-th AP. A total transmit power of the m-th dAP may be defined as Equation 11 below.

$${P}_{m} {=}^{△} {\{ {p}_{k , m} \}}_{k ∈ 𝒦} \qquad [ Equation 11 ]$$

This may depend on the maximum power P per dAP, such as [symbol] \sqrt{p_{k,m}}≤P, m∈ [symbol] . An achievable data rate Rₖ of the k-th terminal may be expressed as Equation 12 below.

$${R}_{k} ( \hat{h} , e , p ) = {log}_{2} ( 1 + {SINR}_{k} ( \hat{h} , e , p ) ) \qquad [ Equation 12 ]$$

In Equation 12, an index set of the local CSI estimates for the m-th dAP may be ĥ≙ [symbol] , an index set of channel estimation errors for the m-th dAP may be e≙ [symbol] , and an index set of the maximum powers for the m-th dAP may be p≙ [symbol] . A signal to interference plus noise ratio (SNIR) for the k-th terminal may be defined as in Equation 13 below.

$$\begin{matrix}{SINR}_{k} ( \hat{h} , e , p ) = \frac{{\vert {\sum }_{m ∈ ℳ} {h}_{k , m} {x}_{m} \vert}^{2}}{1 + {\sum }_{i ∈ 𝒦 ∖ \{ k \}} {\vert {\sum }_{m ∈ ℳ} {h}_{k , m} {x}_{i} \vert}^{2}} \\ = \frac{{\vert {\sum }_{m ∈ M} ( {\hat{h}}_{k , m} + {e}_{k , m} ) {w}_{k , m} \sqrt{{p}_{k , m}} \vert}^{2}}{1 + {\sum }_{i ∈ 𝒦 ∖ \{ k \}} {\vert {\sum }_{m ∈ M} ( {\hat{h}}_{k , m} + {e}_{k , m} ) {w}_{k , m} \sqrt{{p}_{i , m}} \vert}^{2}}\end{matrix} \qquad [ Equation 13 ]$$

In the present disclosure, a network utility function U(ĥ, e, p) needs to be maximized by optimizing the transmit power p with respect to channel statistics (ĥ, e, ρ). Popular choices for the network utility function U(•) may be a sum-rate (SR), minimum-rate (MR), or proportional-fairness (PF), each of which may be expressed as Equation 14 to Equation 16.

$${U}_{SR} ( \cdot ) = {\sum }_{k ∈ 𝒦} {R}_{k} ( \hat{h} , e , p ) \qquad [ Equation 14 ]$$

$${U}_{MR} ( \cdot ) = {min}_{k ∈ 𝒦} {R}_{k} ( \hat{h} , e , p ) \qquad [ Equation 15 ]$$

$${U}_{PF} ( \cdot ) = {\sum }_{k ∈ 𝒦} ln {R}_{k} ( \hat{h} , e , p ) \qquad [ Equation 16 ]$$

In other words, Equation 14 represents a case of maximizing the network utility function U(•) using the sum-rate (SR), Equation 15 represents a case of maximizing the network utility function U(•) using the minimum rate (MR), and Equation 16 represents a case of maximizing the network utility function U(•) using the proportional-fairness (PF).

Accordingly, the optimization problem for maximizing the network utility may be expressed as Equation 17 below.

$${max}_{p} {𝔼}_{\hat{h} , e , p} U . ( {R}_{k} ( \hat{h} , e , p ) ) \qquad [ Equation 17 ]$$

$$s . t . {\sum }_{k ∈ 𝒦} \sqrt{{p}_{k , m}} \leq P , m ∈ ℳ$$

In the following description, for convenience of description, the first row (top line) of Equation 17 will be described as Equation 17a, and the second row (bottom line) of Equation 17 will be described as Equation 17b.

Equation 17 is generally nonconvex. Therefore, it is not easy to obtain a globally optimal solution therefor. An expected value for a randomly distributed CSI (ĥ, e, ρ) has no analytical formula. This makes it difficult to apply traditional nonconvex optimization techniques. Methods known to date propose a traceable closed-form approximation for an utility based on an average transmission rate. According to the approximation method, all short-term fading coefficients may be simply removed using Jensen's inequality, which leads to model mismatch between a transmission rate and its approximated value. In addition, since the representation of the approximated rate relies only on long-term channel statistics, there is no room to utilize short-term CSI in optimizing power control parameters. Moreover, the individually deployed dAPs 111, 112, . . . , and 113 require a new decentralized calculation structure.

Each of the dAP 111, 112, . . . , and 113 may need to infer its local power allocation solution pₘ based only on partial network knowledge, that is, the local CSI vectors ĥₘ and ρₘ. Such partial observations are insufficient to individually recover the optimal solution of Equation 17. Therefore, interaction between the dAPs 111, 112, . . . , and 113 may be essential to configure effective power control schemes.

The present disclosure proposes a low-complexity solution to Equation 17 described above using deep learning technology. In addition, as described above, there is no optimal solution to Equation 17. Therefore, in the present disclosure, instead of adopting supervised learning methods, a method for identifying an unsupervised deep learning framework is used. This can be implemented even without knowledge of the optimal solution to Equation 17.

In the present disclosure, the original problem presented in Equation 17 is transformed into a ‘functional optimization’ problem to be suitable for generalized learning. According to this transformation, the targets of optimization may be transformed into a function representative of the optimization procedure. An arbitrary problem with specified inputs and outputs can be refined into functional optimization tasks.

In addition, Equation 17 may be regarded as a procedure for identifying a solution p for arbitrarily given channel statistics (ĥ, e, ρ) and system parameter P. This input-output relationship may be captured by a functional operator p= [symbol] (ĥ, ρ, P). By applying the functional operator to Equation 17 described above, functional optimization expressed as Equation 18 below may be obtained.

$${max}_{𝒢 ( \cdot )} {𝔼}_{\hat{h} , e , p} U . ( \hat{h} , e , 𝒢 ( \hat{h} , ρ , P ) ) s . t . {\sum }_{k ∈ 𝒦} \sqrt{{p}_{k , m}} \leq P , m ∈ ℳ \qquad [ Equation 18 ]$$

In the following description, for convenience of description, the first row (top line) of Equation 18 will be described as Equation 18a, and the second row (bottom line) of Equation 18 will be described as Equation 18b. In addition, it can be seen that Equation 18b is the same as Equation 17b described above.

As a result, by solving Equation 18, a general mapping rule [symbol] (⋅) for an arbitrarily given input {ĥ, e, ρ, P} may be obtained.

In the present disclosure, the operator [symbol] (⋅), which is the mapping rule, may be designed through cooperation between the CPU 121 and the dAPs 111, 112, . . . , and 113, so that computing powers and short-term CSIs of the dAPs 111, 112, . . . , and 113 can be utilized maximally while minimizing the fronthaul overhead.

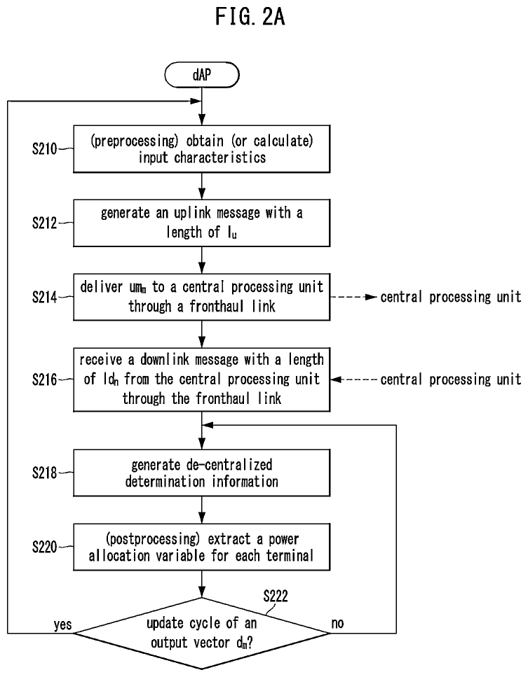

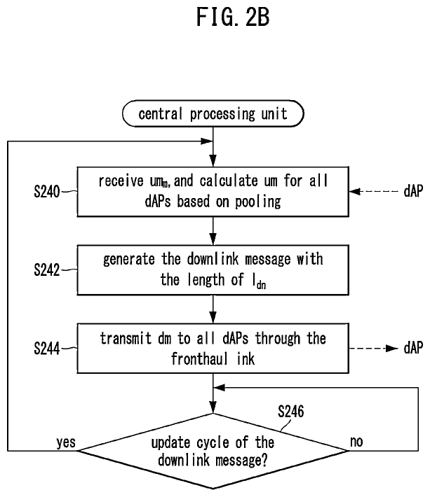

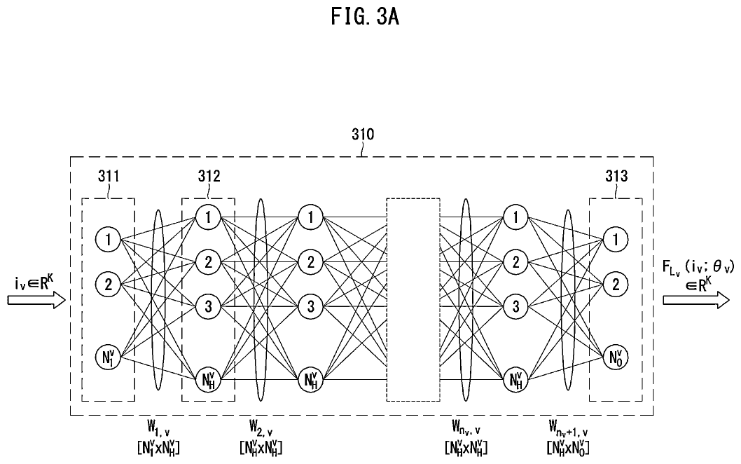

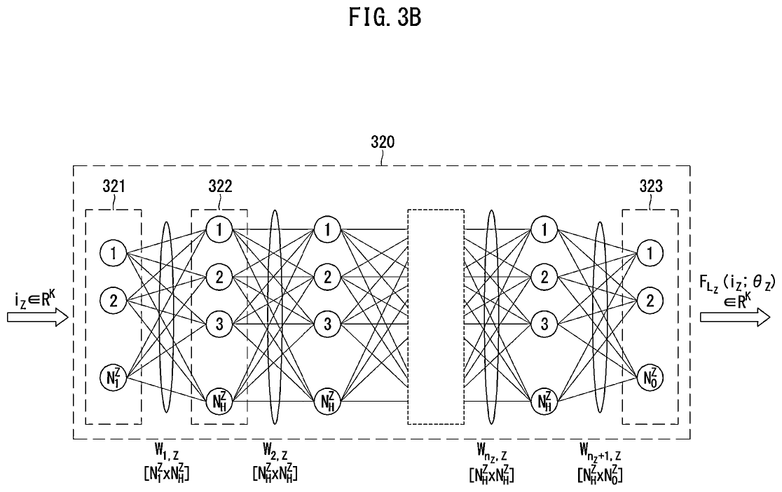

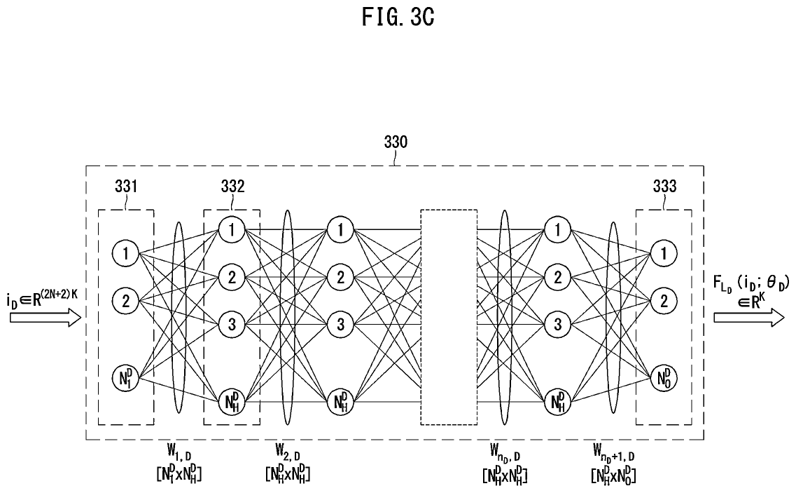

For this purpose, the operator [symbol] (⋅), which is the mapping rule, may be divided into an uplink fronthaul cooperation message generation operator [symbol] (⋅) and a distributed power allocation determination operator [symbol] (⋅) performed in each dAP, and a downlink fronthaul cooperation message generation operator [symbol] (⋅) performed in the CPU. Each of these operators may refer to processing of a deep neural network (DNN) illustrated in FIGS. 3A to 3C, which will be further described with reference to FIGS. 2A and 2B and FIGS. 3A to 3C.

FIG. 2A is a flowchart for cooperative learning with CPU at dAP according to an exemplary embodiment of the present disclosure, and FIG. 2B is a flowchart for cooperative learning with each dAP at CPU according to an exemplary embodiment of the present disclosure.

Operations of FIG. 2A described below may be performed by all of the dAPs 111, 112, . . . , and 113 described in FIG. 1, and operations of FIG. 2B may be performed by the CPU 121 having the configuration of FIG. 1. In addition, dotted lines in FIG. 2A illustrate cases where the dAP transmits/receives a message (or signal or information) with the CPU 121, and dotted lines in FIG. 2B illustrate cases where the CPU 121 transmits/receives a message (or signal or information) with the dAP.

In the following description, when describing operations of the dAP with reference to FIG. 2A, the corresponding operation of the CPU 121 will be described with reference to FIG. 2B as a message (or signal or information) is transmitted to the CPU 121, as shown by the dotted line. Additionally, when describing operations of the CPU with reference to FIG. 2B, the corresponding operation of the dAP will be described with reference to FIG. 2A as a message (or signal or information) is transmitted to the dAP, as shown by the dotted line.

In the following description, the dAP will be described as representing a specific dAP. However, it should be noted that the dAP described below and all dAPs illustrated in FIG. 1 perform the same operations. However, a timing of the operation may be an appropriate time for each dAP.

The CPU 121 may need to collect local information from the dAPs for uplink fronthaul cooperation. Therefore, the CPU 121 may instruct the dAPs 111, 112, . . . , and 113 to perform the operation of FIG. 2A before performing the operation of FIG. 2A. As another example, each of the dAPs 111, 112, . . . , and 113 may be configured in advance to perform the operation of FIG. 2A. As another example, it may be promised that the operation of FIG. 2A is to be performed through signaling between the CPU 121 and the dAPs 111, 112, . . . , and 113.

In describing with reference to FIG. 2A, it should be noted that the dAP is assumed to be an arbitrary m-th dAP.

Referring to FIG. 2A, in step S210, as preprocessing, the m-th dAP may calculate input characteristics defined as Equation 19 as in Equation 20 below.

$${ρ}_{m}^{′} {=}^{Δ} {\{ {ρ}_{k , m}^{′} \}}_{k ∈ 𝒦} \qquad [ Equation 19 ]$$

$${ρ}_{k , m}^{′} = \sqrt{P} \frac{\sqrt{{ρ}_{k , m}}}{{\sum }_{i ∈ 𝒦} \sqrt{{ρ}_{i , m}}} \qquad [ Equation 20 ]$$

First, in Equation 19, ρ′ₘ may be input characteristics for the m-th dAP, and may mean information (or value) on a path loss between the k-th terminal and the m-th dAP.

In Equation 20, data preprocessing may be performed so that the input characteristics, a result of normalizing the long-term local CSI ρₘ, are located within a limited region or have a value within a limited range as shown in Equation 21 below.

$${ρ}_{k , m}^{′} ∈ [ 0 , \sqrt{P} ] \qquad [ Equation 21 ]$$

In step S212, the m-th dAP may generate an uplink message having a length [symbol] _{U} as shown in Equation 22 below by using the input characteristics on which the preprocessing operation of step S210 has been performed as shown in Equation 19. In this case, the length of the uplink message may be a predetermined length. The predetermined length value may be a length agreed with the CPU 121 or a length indicated (or set) by the CPU 121. By setting the length of the uplink message to a specific value, learning may be performed without changing the size of DNNs described in FIGS. 3A to 3C even when the number of dAPs changes. Therefore, although not illustrated in FIGS. 2A and 2B, the procedure for indicating or setting the length of the uplink message may be performed in advance.

$${um}_{m} = {V}_{m} ( {ρ}_{m}^{′} ; {Θ}_{{v}_{m}} ) \qquad [ Equation 22 ]$$

The uplink message umₘ in Equation 22 may have a relationship shown in Equation 23.

$${um}_{m} ∈ {ℝ}^{{ϑ}_{U}} \qquad [ Equation 23 ]$$

In Equation 22, [symbol] may be implemented using parameters [symbol] trainable in the m-th dAP. Here, when the operation of the dAP is implemented using DNN(s), the trainable parameters [symbol] may mean connection weights between nodes constituting the respective layers described below. As in Equation 22, the m-th dAP belonging to the total M dAPs may use a dedicated individual operator [symbol] . However, this scheme lacks flexibility for the number M of dAPs. In other words, there is a problem that a group of operators [symbol] implemented based on the specific total number M of the dAPs cannot be applied equally to networks with different number of dAPs.

Due to this problem, networks with a variable number of dAPs may need to implement multiple operators for all possible distributed MIMO configurations. In other words, there is a problem of having to implement a plurality of operators in advance in various forms to determine which operator to use based on the number of dAPs in the distributed MIMO network where the dAPs are deployed.

To solve this problem, the present disclosure proposes to adopt a scalable architecture in which operator implementation is independent of the number M of APs. In other words, all dAPs reuse the same operator as shown in Equation 24 below to realize the corresponding uplink message generation inference.

$$v ( \cdot ; {Θ}_{v} ) \qquad [ Equation 24 ]$$

When using the operator of Equation 24, the uplink message umₘ generated by the dAP may be modified as Equation 25 below instead of Equation 22.

$${um}_{m} = v ( {p}_{m}^{′} ; {Θ}_{v} ) \qquad [ Equation 25 ]$$

Accordingly, the m-th dAP according to the present disclosure may generate the uplink message as exemplified in Equation 25 using trainable parameters that can be used regardless of the number of dAPs, as shown in Equation 25 in step S212. In this case, the length of the uplink message may be set to the length described above. From Equation 25, it can be seen that the operator [symbol] has no dependence on m. This allows the same operator [symbol] to be used in all dAPs, and the output uplink message may vary depending on the input of the operator. As a result, since the operator is replaced by a neural network, there is an advantage in that the same neural network can be used for all dAPs regardless of the number of dAPs.

In step S214, the m-th dAP may deliver the uplink message generated as shown in Equation 25 to the CPU 121 through a fronthaul link.

Steps S210 to S214 described above may be performed in all dAPs as described above.

Then, the operations performed by the CPU 121 will be described below with reference to FIG. 2B.

In step S240, the CPU 121 may receive the uplink messages umₘ from the M dAPs 111, 112, . . . , and 113. In this case, the CPU 121 may calculate the uplink messages umₘ received from all dAPs as one uplink message as shown in Equation 26 below based on pooling.

$$um = \frac{{\sum }_{m ∈ ℳ} {um}_{m}}{M} \qquad [ Equation 26 ]$$

The operation of Equation 26 may use a superposition coding concept of a non-orthogonal multiple access system. Through this, unnecessary statistics may be removed and important uplink message characteristics um may be extracted from individual dAP message vectors [symbol] without changing the message length. As a result, dimension-independent fronthaul cooperation can be effectively utilized.

In step S242, the CPU 121 may use the operator [symbol] of the CPU 121 with the parameter set [symbol] to convert the pooled information vector into an output (i.e. downlink message with a length of [symbol] _{dn}). Here, the parameter set may mean weights for the connections between nodes included in the respective layers constituting the DNN of the CPU 121. Therefore, the parameter set may be updated when the DNN is trained. In the present disclosure, further description on a learning procedure for the DNNs will be omitted. The configuration (structure) of the DNNs will be described with reference to FIGS. 3A to 3C below. Based on the above description, the operations of the operator may actually correspond to the operations of the DNN processing input data by weights (or parameter set) and outputting it.

In addition, since the length of the uplink message is determined to be a specific value as described above, the length of the downlink message may also be determined to be a specific value. In other words, since one downlink message is generated by performing a pooling operation on the uplink messages, the downlink message may also have a specific length. For example, the downlink message may have the same length as the uplink message.

In addition, the pooled information vector may be exemplified as shown in Equation 27 below, and the downlink message may have a relationship as shown in Equation 28 below.

$$um ∈ {ℝ}^{{ϑ}_{up}} \qquad [ Equation 27 ]$$

$$dm ∈ {ℝ}^{{ϑ}_{dn}} \qquad [ Equation 28 ]$$

The CPU 121 may generate the downlink message in form of Equation 29 below based on the operators of the CPU 121 and Equations 27 and 28.

$$dm = 𝓏 ( um ; {Θ}_{𝓏} ) \qquad [ Equation 29 ]$$

The downlink message calculated as in Equation 29 may be a downlink communication message to be broadcast to all dAPs.

Therefore, the CPU 121 may transmit the downlink message to all dAPs through the fronthaul link in step S244. In step S246, the CPU 121 may identify whether an update cycle of the downlink message arrives. When the update cycle of the downlink message does not arrive, the CPU 121 may wait until the update cycle of the downlink message arrives. On the other hand, when the update cycle of the downlink message arrives, the CPU 121 may repeatedly perform steps S240 to S244 described above.

The procedures of steps S240 to S244 described above may be a downlink message generation operation using long-term CSI. Therefore, the update cycle of the downlink message in step S246 may be set to a cycle at which the long-term CSI statistics change.

As described in FIG. 2A above, the update cycle of the downlink message may be determined individually by the dAP or by the CPU 121. If the CPU 121 determines the update cycle, channel change information reported in advance from the respective dAPs may be used. It should be noted that an operation of transmitting channel change information is not illustrated in FIGS. 2A and 2B.

Meanwhile, in the operation described above, the CPU 121 performs a pooling operation on all dAPs as in Equation 26 in step S240 and then generates the downlink communication message as in Equation 30 in step S242. However, another method is also possible. For example, the CPU 121 may change the order of the pooling operation and the downlink message generation operation. In other words, if the CPU 121 defines the latent characteristics of the uplink message umₘ as in Equation 30 below, the latent characteristics of the uplink message may be extracted as in Equation 31 below.

$${dm}_{m} ∈ {ℝ}^{{ϑ}_{dn}} \qquad [ Equation 30 ]$$

$${dm}_{m} = 𝓏 ( {um}_{m} ; {Θ}_{𝓏} ) \qquad [ Equation 31 ]$$

The unique operator [symbol] for the uplink messages in Equation 25 may parallelly generate a group of information vectors expressed as Equation 32 below.

$${\{ {dm}_{m} \}}_{m ∈ ℳ} \qquad [ Equation 32 ]$$

The CPU 121 may use the concept of superposition coding of a non-orthogonal multiple access system, thereby generating a downlink message vector dm as shown in Equation 33 below as an average for the m-th dAP, which is an element of the M dAPs.

$$dm = \frac{{\sum }_{m ∈ ℳ} {dm}_{m}}{M} \qquad [ Equation 33 ]$$

Based on one of the two schemes described above, the CPU 121 may transmit the downlink message to all dAPs in step S244. Accordingly, the m-th dAP in FIG. 2A may receive the downlink message in step S216. In other words, the m-th dAP may receive the downlink message generated as in Equation 30 or the downlink message as in Equation 33 from the CPU 121.

Referring again to FIG. 2A, the m-th dAP that receives the downlink message from the CPU 121 in step S216 may perform step S218.

In step S218, the m-th dAP may generate decentralized determination information. Hereinafter, generation of the decentralized determination information will be described. The m-th dAP may determine a local power allocation value (i.e. total transmit power of the m-th dAP) using the local CSI, which is its input characteristics expressed as Equation 19, and an estimate of the short-term CSI defined as Equation 5. Since the total transmit power of the m-th dAP needs to satisfy Equation 17b described above, one operator with parameters [symbol] trainable in all dAPs may be implemented as shown in Equation 34 below. Here, the parameters trainable in each of all dAPs may be the same parameters.

$$𝒟 ( \cdot ; {Θ}_{𝒟} ) \qquad [ Equation 34 ]$$

If an output result by the operator of Equation 34 is dₘ, the local power allocation value pₘ may be determined using the output result. In other words, the m-th dAP may implement calculation of the operator of Equation 34 as shown in Equation 35 below.

$${d}_{m} = 𝒟 ( dm , {ρ}_{m}^{′} , {\hat{h}}_{m} ; {Θ}_{𝒟} ) \qquad [ Equation 35 ]$$

The output vector dₘ of the operator exemplified in Equation 34 may be defined as shown in Equation 36 below.

$${d}_{m} = [ {d}_{1 , m} … {d}_{K , m} , {δ}_{m} ] ∈ {ℝ}^{K + 1} \qquad [ Equation 36 ]$$

Then, the remaining elements d_{k,m}≥0, ∀k∈ [symbol] excluding the last element exemplified in Equation 36 may control a ratio between transmit power variables defined as in Equation 37 below. The information described above may be the decentralized determination information. In other words, the output vector dₘ of the operator shown in Equation 34 and the last element of Equation 36 may be used as the decentralized determination information. In the following description, the last element δₘ of Equation 36 will be referred to as ‘first information for decentralization decision’, and δₘ may be a variable for the m-th dAP.

The m-th dAP may extract a power allocation variable for each terminal in step S220. The power allocation variable for each terminal may correspond to a postprocessing operation. Therefore, a ratio between transmit power variables defined by Equation 37 below may be a power allocation variable for each terminal.

$${p}_{k , m} , ∀ k ∈ 𝒦 \qquad [ Equation 37 ]$$

On the other hand, the last element of Equation 36, the first information for decentralized determination, may determine the total transmit power to be consumed by the m-th dAP. In order to limit a possible range of the first information for decentralized determination, which is the last element of Equation 36, to [0,P], the first information for decentralized determination may be normalized as in Equation 38 below. Here, P may be the maximum power value that can be transmitted by the m-th dAP, as described above.

$${δ}_{m} ← P min ( max ( {δ}_{m} , 0 ) , 6 ) / 6 \qquad [ Equation 38 ]$$

In addition, the power allocation variable p_{k,m} may be recovered from the output vector dₘ of the operator in Equation 34 as shown in Equation 39 below.

$${p}_{k , m} = {δ}_{m} \frac{{d}_{k , m}}{{\sum }_{i ∈ 𝒦} {d}_{i , m}} \qquad [ Equation 39 ]$$

The results according to Equation 38 and Equation 39 may always lead to a solution that satisfies the power constraints of Equation 17b described above, as shown in Equation 40 below.

$${\sum }_{k ∈ 𝒦} {p}_{k , m} = {δ}_{m} \leq P \qquad [ Equation 40 ]$$

The generation cycle of the downlink message dₘ received from the CPU 121 and the update cycle of the uplink message of the m-th dAP may be determined according to the long-term CSI change cycle. The long-term CSI change cycle has a relatively much larger value than a short-term CSI change cycle. Therefore, the fronthaul overhead caused by exchanging two messages is much smaller than the overhead caused by short-term CSI exchange.

In addition, considering that short-term CSI is used as an input to the operator of Equation 35 as shown in Equation 36, the m-th dAP may repeat the process of deriving power allocation variables for the respective terminals with a short-term CSI change cycle using the same downlink message dₘ. The power allocation variable for each terminal may be expressed as Equation 39 described above.

Finally, in step S222, the dAP may identify whether the update cycle of the output vector dₘ arrives. When the update cycle of the output vector dₘ arrives, the dAP may proceed to step S210, and when the update cycle of the output vector dₘ does not arrive, the dAP may proceed to step S218. FIG. 2A illustrates the case of proceeding to step S218, but the dAP may proceed to step S220.

The output vector may be the downlink message dₘ as described above, and the output vector may be a vector that determines the transmit power. The update cycle of the output vector may be set in various manners.

For example, the update cycle of the output vector may be set in advance by the CPU 121. When it is preset by the CPU 121, the CPU 121 may transmit the set output vector update cycle to each of the dAPs. As another example, the update cycle of the output vector may be set independently by each dAP.

When the CPU 121 or each dAP determines the update cycle of the output vector, the following methods may be used.

The update cycle of the output vector may be determined based on channel variability. For example, when a dAP is installed in an area where many high-speed vehicles move, such as near a highway, the channel may change very quickly. In cases where the channel change speed is fast, the update cycle of the output vector may be set to a short value. On the other hand, in cases where the movement speed of most users is slow, such as in schools, factories, large buildings, etc., the update cycle of the output vector may be set to a long value. In addition, in areas where vehicle movement and human movement are mixed, the update cycle of the output vector may be determined based on an average channel change speed. As another example, a channel change cycle may be individually set for each individual terminal. As another example, a channel change cycle may be set for each specific group.

Setting the channel change cycle for each individual terminal or specific group may be necessary in the following cases. For example, assuming a highway rest area, vehicles that do not stop at the rest area may move at high speeds. On the other hand, users moving within the highway rest area may move at a very slow speed compared to vehicles. Therefore, in this case, if an average of the two values is used, both users in the rest area and high-speed vehicles may experience unsatisfactory channel environments. Therefore, in the above-described environment, individual users may be divided into groups of high-speed moving objects and low-speed users, and the channel change cycle may be set for each group.

When the channel change cycle described above is determined by the CPU 121 and transmitted to each dAP, each of the dAPs may receive and use it. On the other hand, when each dAP determines the channel change cycle, information on the channel change cycle determined by each dAP may be reported to the CPU 121. It should be noted that FIG. 2A does not illustrate a procedure for reporting such information on the channel change cycle.

To summarize the operations described above with reference to FIGS. 2A and 2B, the group of operators presented in Equations 20, 22, 25, 26, 30, 31, 33, and 35 may provide an end-to-end forward pass mapping [symbol] (⋅; Θ) of the cooperative operation according to the present disclosure as p= [symbol] (ρ, ĥ; Θ). Here, the end-to-end forward pass mapping factor may be defined as Equation 41 below.

$$Θ {=}^{△} \{ {Θ}_{𝒱} , {Θ}_{𝒵} , {Θ}_{𝒟} \} \qquad [ Equation 41 ]$$

The end-to-end forward pass mapping factor expressed as Equation 41 may represent collection of all trainable parameters.

The remaining task is to design correct DNNs that successfully approximate the intractable operator [symbol] (⋅). In general, it has been theoretically shown that DNN can approximate arbitrary functions within a small error.

Based on the methods described above, each dAP can communicate with at least one terminal that communicates with it through beamforming.

In the present disclosure, the operator of Equation 24 expressed as Equation 25, the operator [symbol] defined as Equation 31 that calculates the latent characteristics of the uplink message defined as Equation 30, and the operator [symbol] defined as Equation 35 may be modeled as DNNs that perform basic computational functions to approximate the operator [symbol] (⋅). Hereinafter, a method of modeling such the DNNs will be described with reference to FIGS. 3A to 3C.

FIG. 3A is a conceptual diagram for describing a structure of an uplink fronthaul cooperation message generation operator DNN among the cooperative learning operation functions according to the present disclosure, FIG. 3B is a conceptual diagram for describing a structure of a downlink fronthaul cooperation message generation operator DNN among the cooperative learning operation functions according to the present disclosure, and FIG. 3C is a conceptual diagram for describing a structure of a distributed power allocation determination operator DNN among the cooperative learning operation functions according to the present disclosure.

In the present disclosure, ‘cooperation’ may mean cooperation between computational operations in a processor included in the dAP or a DNN driven by the processor and computational operations in a processor included in the CPU 121 or a DNN driven by the processor. In other words, this may refer to a procedure in which, in order to obtain a final result, a result of a first operation (or processing) performed in the dAP is received by the CPU 121, a second operation (or processing) is performed by the CPU 121, and a third operation (processing) is performed by the CPU 121 on a result of the second operation (or processing).

In addition, parameters of the DNN may be specified by a learning procedure. Therefore, in the present disclosure, cooperative learning may refer to a process of training the DNNs provided in each of the dAP and the CPU 121 through cooperation between the dAP and the CPU 121, or a procedure performed by the DNN provided in each of the dAP and the CPU 121 using the trained parameters.

FIGS. 3A to 3C show an exemplary embodiment considering fully-connected DNNs. However, various forms of DNN may be used. For example, an input vector of length N₀ may be defined as shown in Equation 42 below.

$$i ∈ {ℝ}^{{N}_{0}} \qquad [ Equation 42 ]$$

For the input vector defined as Equation 42, calculations of an L-layer DNN with a trainable parameter set Θ may be given as Equation 43 below.

$${ℱ}_{L} ( i ; Θ ) = {a}_{L} ( {W}_{L} \times … \times {a}_{1} ( {W}_{1} i + {o}_{1} ) + … + {o}_{L} ) \qquad [ Equation 43 ]$$

In Equation 43, aₗ(⋅), l=1, . . . , L may be an activation function of an l-th layer, and when Nₗ represents an output resource of the l-th layer, a weight matrix may be expressed as Equation 44 below, and a bias vector may be expressed as Equation 45 below.

$${W}_{l} ∈ {ℝ}^{{N}_{l - 1} \times {N}_{l}} \qquad [ Equation 44 ]$$

$${o}_{l} ∈ {ℝ}^{{N}_{l}} \qquad [ Equation 45 ]$$

These may constitute the trainable parameter set described above, and the trainable parameter set may be expressed as Equation 46 below.

$$Θ {=}^{△} \{ {W}_{l} , {o}_{l} : ∀ l \} \qquad [ Equation 46 ]$$

The operators (⋅; [symbol] ), [symbol] , and [symbol] for calculating the end-to-end forward pass mapping factors expressed in Equation 41 may be respectively modeled as DNNs as shown in Equations 47 to 49 below.

$${ℱ}_{{L}_{𝒱}} ( {i}_{𝒱} ; {Θ}_{𝒱} ) \qquad [ Equation 47 ]$$

$${ℱ}_{{L}_{𝒵}} ( {i}_{𝒵} ; {Θ}_{𝒵} ) \qquad [ Equation 48 ]$$

$${ℱ}_{{L}_{𝒟}} , ( {i}_{𝒟} ; {Θ}_{𝒟} ) \qquad [ Equation 49 ]$$

In this case, the input vector of the uplink fronthaul cooperation message generation operator DNN illustrated in FIG. 3A may be expressed as Equation 50 below, the input vector of the downlink fronthaul cooperation message generation operator DNN illustrated in FIG. 3B may be expressed as Equation 50 below, and the input vector of the distributed power allocation determination operator DNN illustrated in FIG. 3C may be expressed as Equation 52 below.

$${i}_{𝒱} = \{ {p}_{m}^{′} \} ∈ {ℝ}^{K} \qquad [ Equation 50 ]$$

$${i}_{𝒵} = \{ u m \} ∈ {ℝ}^{K} \qquad [ Equation 51 ]$$

$${i}_{𝒟} = \{ dm , {p}_{m}^{′} , {\hat{h}}_{m} \} ∈ {ℝ}^{( 2 N + 2 ) K} \qquad [ Equation 52 ]$$

In FIG. 3A, the uplink fronthaul cooperation message generation operator DNN 310 may include a plurality of hidden layers between an input layer 311 and an output layer 313. It should be noted that the hidden layers may be composed of one or multiple hidden layers. When there are multiple hidden layers, each of a first hidden layer 312 and subsequent hidden layers may constitute one hidden layer, as illustrated in FIG. 3A.

Information input to each node of the input layer 311 may be a normalized value of the long-term local CSI, as previously described in FIG. 2A. In other words, it may be a value generated using information measured (or reported from the terminal) on a channel state between the m-th dAP and each terminal.

In FIG. 3A, a case where the output of each layer is expressed as a single function is illustrated using equations below. For example, the output of the input layer 311 may be expressed as W_{1,v}, the output of the first hidden layer 312 may be expressed as W_{2,v}, and the output of the output layer 313 may be expressed as Wₙ_{ᵥ}_{+1,v}. The outputs of the respective layers illustrated in FIG. 3A may be determined by parameters as described above, and the parameters may be connection weights between nodes constituting the respective layers. These parameters may be determined (or updated) based on the learning of the DNN.

Referring to FIG. 3B, the downlink fronthaul cooperation message generation operator DNN 320 illustrates a form that includes a plurality of hidden layers between an input layer 321 and an output layer 323. It should be noted that the hidden layers of the downlink fronthaul cooperation message generation operator DNN 320 may also be composed of one or multiple hidden layers. When there are multiple hidden layers, each layer may constitute one hidden layer, each of a first hidden layer 322 and subsequent hidden layers may constitute one hidden layer, as illustrated in FIG. 3B.

In FIG. 3B, a case where the output of each layer is expressed as a single function is illustrated using equations below. For example, the output of the input layer 321 may be expressed as W_{1,Z}, the output of the first hidden layer 322 may be expressed as W_{2,Z}, and the output of the output layer 323 may be expressed as Wₙ_{_{Z}}_{+1,Z}. The outputs of the respective layers illustrated in FIG. 3B may also be determined by parameters as described above, and the parameters may be connection weights between nodes constituting the respective layers. These parameters may be determined (or updated) based on the learning of the DNN.

Referring to FIG. 3C, the distributed power allocation determination operator DNN 330 illustrates a form that includes a plurality of hidden layers between an input layer 331 and an output layer 333. It should be noted that the hidden layers of the distributed power allocation determination operator DNN 320 may also be composed of one or multiple hidden layers. When there are multiple hidden layers, each of a first hidden layer 332 and subsequent hidden layers may constitute one hidden layer, as illustrated in FIG. 3C.

In FIG. 3C, a case where the output of each layer is expressed as a single function is illustrated using equations below. For example, the output of the input layer 331 may be expressed as W_{1,D}, the output of the first hidden layer 332 may be expressed as W_{2,D}, and the output of the output layer 333 may be expressed as Wₙ_{_{D}}_{+1,D}. The outputs of the respective layers illustrated in FIG. 3C may also be determined by parameters as described above, and the parameters may be connection weights between nodes constituting the respective layers. These parameters may be determined (or updated) based on the learning of the DNN.

The m-th dAP may allocate power to a channel (or signal) transmitted to each of the terminals communicating within the m-th dAP based on the output of the distributed power allocation determination operator DNN 330 illustrated in FIG. 3C.

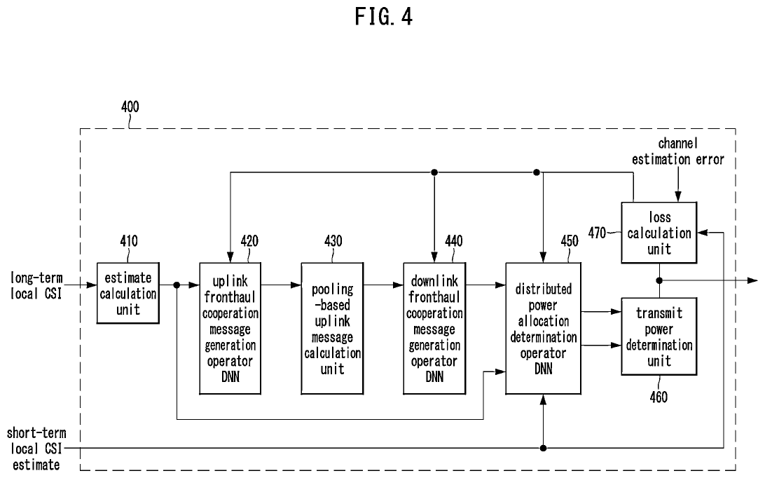

FIG. 4 is a conceptual diagram for describing a cooperative learning-based power allocation deep neural network structure according to an exemplary embodiment of the present disclosure.

Referring to FIG. 4, configuration of a cooperative learning-based power allocation deep neural network 400 is illustrated. The power allocation deep neural network 400 may perform an operation based on parameter update according to the present disclosure. With reference to FIG. 4, the configuration and operation of the collaborative learning-based power allocation deep neural network 400 according to the present disclosure will be described.

Device local CSI may be output by an estimate calculation unit 410 calculating the short-term CSI estimate. The short-term CSI estimate may be input to an uplink fronthaul cooperation message generation operator DNN 420. The uplink fronthaul cooperation message generation operator DNN may perform the operation as previously described in FIG. 3A, and provide an operation result to a pooling-based uplink message calculation unit 430. The uplink message calculation unit 430 may calculate one uplink message based on pooling, as previously described in step S240 of FIG. 2B. The uplink message calculated by the uplink message calculation unit 430 may be input to a downlink fronthaul cooperation message generation operator DNN 440. The downlink fronthaul cooperation message generation operator DNN 440 may perform the operation as previously described in FIG. 3B. An operation result of the downlink fronthaul cooperation message generation operator DNN 440 may be input to a distributed power allocation determination operator DNN 450. The distributed power allocation determination operator DNN 450 may perform the operation previously described in FIG. 3C. In this case, as illustrated in FIG. 4, the distributed power allocation determination operator DNN 450 may use the output of the estimate calculation unit 410, the output of the downlink fronthaul cooperation message generation operator DNN 440, and the short-term CSI estimate as inputs.

The distributed power allocation determination operator DNN 450 may generate a downlink communication message to be broadcast to all dAPs, and calculate and output the first information for decentralized determination as previously described in Equation 36.

The downlink communication message and the first information for decentralized determination that are the output of the distributed power allocation determination operator DNN 450 may be input to a transmit power determination unit 460. The transmit power determination unit 460 may use each input to generate power allocation variables through calculations such as Equation 39 described above.

The power allocation variables may be used as an output of the power allocation deep neural network 400, and simultaneously input to a loss calculation unit 470.

The loss calculation unit 470 may calculate a loss value using the power allocation variables, channel estimation error, and short-term local CSI estimate as inputs. The loss value calculated may be input to the uplink fronthaul cooperation message generation operator DNN 420, the downlink fronthaul cooperation message generation operator DNN 440, and the distributed power allocation determination operator DNN 450.

Hereinafter, a derivation process by which the power allocation deep neural network 400 as shown in FIG. 4 is constructed.

As previously described with reference to FIGS. 2A and 2B, the end-to-end forward pass mapping factor of cooperative operations may be provided as in Equation 53 below.

$$p = 𝒢 ( p , \hat{h} ; Θ ) \qquad [ Equation 53 ]$$

By substituting the value of Equation 53 into Equation 17 described above, a DNN training problem such as Equation 54 below may be established.

$${max}_{Θ} {𝔼}_{\hat{h} , e , p} U \cdot ( {R}_{k} ( \hat{h} , e , 𝒢 ( ρ , \hat{h} ; Θ ) ) ) \qquad [ Equation 54 ]$$

Equation 17b, which is the power limitation, may be eliminated from Equation 54. The reason is that the power limit is always satisfied by Equation 38 and Equation 39 described above. Therefore, the training problem of Equation 54 may be directly handled by mini-batch stochastic gradient descent (SGD) algorithms such as an Adam optimizer. A loss function used in SGD algorithms may be defined as Equation 55 below.

$$𝕃 ( Θ ) = - {𝔼}_{\hat{h} , e , p} [ U \cdot ( \{ {R}_{k} ( \hat{h} , e , 𝒢 ( ρ , \hat{h} ; Θ ) ) : ∀ k ∈ 𝒦 \} ) ] \qquad [ Equation 55 ]$$

A training data set may include numerous realizations of long-term CSI ρ. At each training epoch, one mini-batch set comprising long-term CSIs may be arbitrarily selected. The long-term CSIs may be collected in advance by experiments or generated based on well-known dAP-UE deployment scenarios.

Then, short-term CSI estimates and error vectors may be generated using known distributions as shown in Equation 7. Since an error rate ϕ in Equation 7 randomly changes in real situations, it is necessary to construct multipurpose DNNs that are adaptive to the randomly changing Φ. To this end, in the present disclosure, an error rate factor may be randomly generated in the training step. In other words, it may be generated from a uniform distribution ϕ˜ [symbol] (0,1).

As a result, the cooperative learning proposed in the present disclosure may be universally adapted to the arbitrary CSI error statistics ϕ. These may be utilized to calculate a gradient of Equation 54, which is a training target averaged over the mini-batch set. As a result, according to the cooperative learning proposed in the present disclosure, several artificially generated CSI error samples may be observed and trained. By observing and training CSI error samples as described above, the DNN may support a powerful power allocation mechanism by learning an unknown distribution of actual CSIs based on the estimates.

The proposed cooperative training process as shown in FIG. 4 may be implemented in an offline manner by collecting all element DNNs. The trained DNN modules may be loaded (or mounted, or stored) on the dAPs and the CPU 121 for power allocation optimization based on cooperative learning.

At this implementation stage, CSI errors are no longer needed, since the proposed cooperative learning only uses long-term CSIs and short-term CSI estimates, as defined by Equation 53.

The number M of dAPs may be considered as a hyper-parameter of the proposed cooperative learning strategy. When the number of dAPs considered in the training phase is assumed to be Mₜᵣₐᵢₙ, in order to further improve scalability, it needs to be carefully selected so that a result of the proposed cooperative learning based on a specific Mₜᵣₐᵢₙ works well universally over a wide range of test dAP numbers Mₜₑₛₜ. Small or large Mₜᵣₐᵢₙ values may cause overfitting problems in which the result of cooperative learning only works in a specific network configuration. Therefore, the optimal choice for Mₜᵣₐᵢₙ may not be equal to the test dAP number Mₜₑₛₜ.

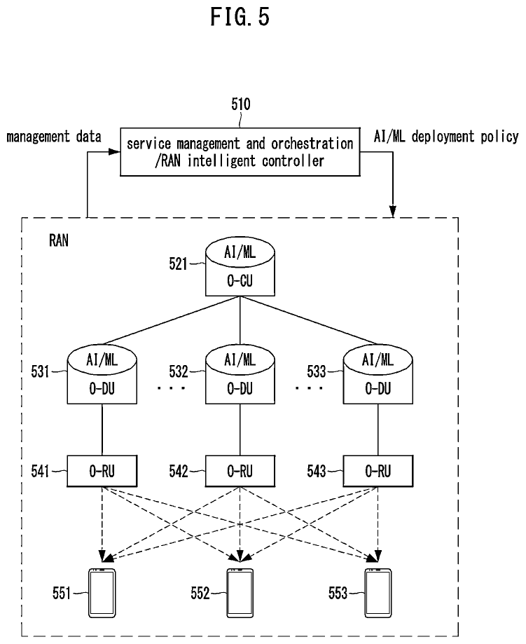

FIG. 5 is a conceptual diagram of an open RAN system configuration to which a cooperative learning-based DNN according to the present disclosure is applied.

FIG. 5 illustrates an exemplary embodiment of configuring a distributed MIMO system in an open radio access network (O-RAN) architecture. Hereinafter, operations of performing real-time RAN intelligent control (RT-RIC) by applying cooperative learning according to the present disclosure, and components therefor will be described with reference to FIG. 5.

According to the O-RAN architecture, a RAN 520 may be configured with three types of logical functional units—an O-RAN central unit (O-CU) 521, O-RAN distributed units (O-DUs) 531, 532, and 533, and O-RAN radio units (O-RUs) 541, 542, and 543. The O-RUs 541, 542, and 543 may communicate with terminals 551, 552, and 553, respectively. Here, the terminals 551, 552, and 553 may correspond to the terminals 101, 102, and 103 previously described in FIG. 1.

As illustrated in FIG. 5, each of the O-DUs 531, 532, and 533 may perform artificial intelligence (AI)/machine learning (ML). The O-CU 521 may also apply AI/ML. The O-DUs 531, 532, and 533 and the O-CU 521 may be connected with a service management and orchestration (SMO) and a RAN intelligent controller (RIC) 510 that facilitate intelligent control on the RAN 520 through training and deployment of AI/ML models.

More specifically, the SMO/RIC 510 may include a non-real time RIC and a near-real time RIC therein. The SMO/RIC 510 proposed to date may automatically manage life-cycles of AI/ML models. However, the SMO/RIC 510 proposed to date does not consider deployment of AI/ML on the O-CU 521, O-DUs 531, 532, and 533, and O-RUs 541, 542, and 543. Therefore, in the present disclosure, the AI/ML components described in FIGS. 1 to 4 may be deployed in the O-RAN system to which the cooperative learning DNNs are applied, as shown in FIG. 5.

Meanwhile, the dAP of the distributed MIMO system shown in FIG. 1 may include one of the O-RUs 541, 542, and 543 and some functions of one of the O-DUs 531, 532, and 533. Accordingly, the CPU 121 described in FIG. 1 may be regarded as including a part of the O-DUs 531, 532, or 533 and the O-CU 521 illustrated in FIG. 5. However, considering that the channel estimation function is performed in the O-DUs 531, 532, and 533 and that they have greater computing power than the O-RUs 541, 542, and 543, as an exemplary embodiment of the present disclosure, it may be assumed that the dAP performs operations of one of the O-RUs 541, 542, and 543 and one of the O-DUs 531, 532, and 533, and the CPU 121 corresponds to the O-CU 521.

The cooperative learning model illustrated in FIGS. 2 to 4 described above may generate individual cooperative learning models according to beam-direction setting precoding schemes and network utility functions used. The SMO/RIC 510 may selectively deploy cooperative learning models on the O-CU 521 and O-DUs 531, 532, and 533 according to determination of a network operator and/or measured performance data of the RAN.

As another example, the SMO/RIC 510 may deploy all individual cooperative learning models in advance on the O-CU 521 and O-DUs 531, 532, and 533, and select a suitable cooperative learning model according to a situation based on policy information.

The method of deploying the cooperative learning models described above on the O-CU/O-DUs may be performed using the existing interfaces of O-RAN or using newly-defined interfaces.

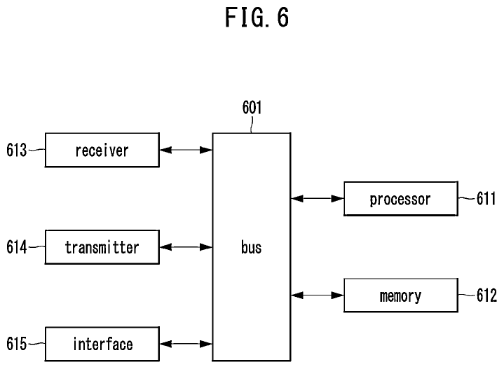

FIG. 6 is a conceptual diagram illustrating block configuration of a device according to an exemplary embodiment of the present disclosure.

The configuration of FIG. 6 may be a partial configuration of the terminals 101, 102, . . . , and 103 of FIG. 1. As another example, the configuration of FIG. 6 may be a partial configuration of each of the M dAPs 111, 112, . . . , and 113. As another example, the configuration of FIG. 6 may be a configuration of the CPU 121. As another example, the configuration of FIG. 6 may be a configuration of one of the O-CU 521, O-DUs 531, 532, and 533, and O-RUs 541, 542, and 543 illustrated in FIG. 5. As another example, the configuration of FIG. 6 may be a configuration of the SMO/RIC 510.

In other words, the configuration of FIG. 6 may be a configuration of each of the communication node or a part thereof. Accordingly, each of the communication nodes may have additional components other than those illustrated in FIG. 6. For example, a terminal may further include a user interface and various sensors. The configuration of FIG. 6 and operations thereof will be described.

Referring to FIG. 6, a processor 611 may control operations of the communication node. For example, when the configuration in FIG. 6 corresponds to a terminal, the processor 611 may control operations of the terminal. As another example, when the configuration of FIG. 6 corresponds to one of the O-CU 521, O-DUs 531, 532, and 533, and O-RUs 541, 542, and 543, the processor 611 may control operations of each communication node. Accordingly, the processor 611 may perform deep learning-based beamforming control according to the present disclosure described in FIGS. 2 to 4. In particular, the processor 611 may control at least some of the operations of the DNNs described in FIGS. 3A to 3C, perform the operations of FIGS. 2A and/or 2B, or control the operations described in FIG. 4.

A memory 612 may store control information for the operations of the DNNs according to the present disclosure and various information for operations in the corresponding communication node.

A receiver 613 may be configured to receive signals from other communication nodes. For example, if a received signal is a radio frequency (RF) signal, the receiver 613 may be configured to receive and process the RF signal. As another example, if a received signal is received through a wired line, the receiver 613 may be configured to process the signal received through the wired line.

A transmitter 614 may be configured to transmit signals to other communication nodes. For example, if an RF signal is transmitted to another communication node, the transmitter 614 may be configured to transmit the RF signal. As another example, if a signal is transmitted through a wired line, the transmitter 614 may be configured to transmit the signal through the wired line.

An interface 615 may provide various interfaces for connection with operators or other devices. For example, when the configuration in FIG. 6 corresponds to one of the O-CU 521, O-DUs 531, 532, and 533, and O-RUs 541, 542, and 543 that constitute the O-RAN, the interface 615 may be O-RAN system internal interfaces or may provide an interface for access of the operators. As another example, when the configuration of FIG. 6 corresponds to a terminal, the interface may provide interfaces for a user to connect with other devices, such as various electronic devices (e.g. other terminals, laptops, computers, PDAs, etc.).

A bus 601 may provide a path for data and/or control signals between the respective components illustrated in FIG. 6.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method for power allocation in a distributed access point (dAP), comprising:
when a change cycle of a transmit power determination vector arrives, generating an uplink message including long-term local channel state information (CSI), the uplink message being normalized such that the long-term local CSI becomes a value within a preconfigured limit range;
transmitting the uplink message to a central processing unit through a fronthaul;
receiving a downlink message vector for power allocation from the central processing unit through the fronthaul;
generating decentralized determination information using the downlink message vector; and
extracting a transmit power determination vector based on the decentralized determination information,
wherein the decentralized determination information includes an output vector for generating a local power allocation value and a variable for the dAP.

2. The method according to claim 1, further comprising:
extracting power allocation information corresponding to each of terminals based on the decentralized determination information;
determining a transmit power for a channel transmitted to each of the terminals based on the power allocation information; and
communicating with each of the terminals by using the determined transmit power.

3. The method according to claim 2, wherein the transmit power for the channel transmitted to each of the terminals is determined by a third preconfigured deep neural network (DNN).

4. The method according to claim 1, wherein the long-term local CSI is calculated based on channel state information and a long-term path loss with each of communicating terminals.

5. The method according to claim 1, wherein the normalized uplink message has a length preset by the central processing unit.

6. The method according to claim 1, wherein the normalized uplink message is generated by a first preconfigured DNN.

7. The method according to claim 1, wherein the change cycle of the transmit power determination vector is determined based on a channel change cycle between a terminal and the dAP.

8. The method according to claim 1, wherein the change cycle of the transmit power determination vector is preset by the central processing unit.

9. The method according to claim 1, wherein the change cycle of the transmit power determination vector is determined differently for each group based on a movement speed of terminals communicating within the dAP.

10. A method of a central processing unit, comprising:
when an update cycle of a downlink message arrives, receiving uplink messages corresponding to long-term local channel state information (CSI) respectively from two or more distributed access points (dAPs) communicating with terminals through a fronthaul;
generating one downlink message based on a pooling operation on the received uplink messages; and
transmitting the downlink message to the dAPs,
wherein each of the uplink messages is information normalized to a value within a preconfigured limit range.

11. The method according to claim 10, wherein the one downlink message is generated by a preconfigured second deep neural network (DNN).

12. The method according to claim 10, further comprising: configuring length information of the uplink message to each of the dAPs.

13. The method according to claim 10, wherein the central processing unit is an open-radio access network (O-RAN) central unit (CU) of an O-RAN system.

14. The method according to claim 10, wherein the update cycle of the downlink message is determined based on channel state change information received from each of the dAPs.

15. The method according to claim 14, further comprising: transmitting information on the update cycle of the downlink message to each of the dAPs.

16. A distributed access point (dAP) comprising a processor, wherein the processor causes the dAP to perform:
when a change cycle of a transmit power determination vector arrives, generating an uplink message including long-term local channel state information (CSI), the uplink message being normalized such that the long-term local CSI becomes a value within a preconfigured limit range;
transmitting the uplink message to a central processing unit through a fronthaul;
receiving a downlink message vector for power allocation from the central processing unit through the fronthaul;
generating decentralized determination information using the downlink message vector; and
extracting a transmit power determination vector based on the decentralized determination information,
wherein the decentralized determination information includes an output vector for generating a local power allocation value and a variable for the dAP.

17. The dAP according to claim 16, wherein the processor further causes the dAP to perform:
extracting power allocation information corresponding to each of terminals based on the decentralized determination information;
determining a transmit power for a channel transmitted to each of the terminals based on the power allocation information; and
communicating with each of the terminals by using the determined transmit power.

18. The dAP according to claim 17, wherein the transmit power for the channel transmitted to each of the terminals is determined by a third preconfigured deep neural network (DNN).

19. The dAP according to claim 16, wherein the long-term local CSI is calculated based on channel state information and a long-term path loss with each of communicating terminals.

20. The dAP according to claim 11, wherein the normalized uplink message has a length preset by the central processing unit.
